(19) United States
(12) Patent Application Publication
(10) Pub. No.: US 2024/0349806 A1
(43) Pub. Date: Oct. 24, 2024

(54) An Aerosol Generating Device and an Aerosol Generating System

(71) Applicant: JT INTERNATIONAL SA, Geneva (CH)

(72) Inventors: Dennis Freie, Zwolle (NL); Jeroen Dammers, Zwolle (NL); Herman Hijma, Kampen (NL)

(73) Assignee: JT INTERNATIONAL SA, Geneva (CH)

(21) Appl. No.: 18/682,244

(22) PCT Filed: Aug. 8, 2022
(86) PCT No.: PCT/EP2022/072281

§ 371 Date: Feb. 8, 2024

(30) Foreign Application Priority Data
Aug. 9, 2021 (EP) 21190416.4

(51) Int. Cl. A24F 40/465; A24F 40/20; A24F 40/57

(52) U.S. Cl. CPC A24F 40/465; A24F 40/57; A24F 40/20

(57) ABSTRACT

An aerosol generating device having a heating chamber for receiving at least part of an aerosol generating substrate and an induction heating arrangement including a single induction coil disposed around or adjacent to the heating chamber for aerosolizing the substrate is provided. The aerosol generating device also includes a controller configured to control the induction heating arrangement to supply an alternating electric current to the single induction coil. The induction heating arrangement has a plurality of connectors associated with the single induction coil which are arranged and configured to permit the supply of the alternating electric current to one or more coil sections to selectively energise the one or more coil sections. The aerosol generating device further includes a plurality of inductively heatable susceptors positioned in the heating chamber adjacent to each coil section to define corresponding heating areas within the heating chamber.

### TECHNICAL FIELD

The present disclosure relates generally to an aerosol generating device, and more particularly to an aerosol generating device for heating an aerosol generating substrate to generate an aerosol for inhalation by a user. Embodiments of the present disclosure also relate to an aerosol generating system comprising an aerosol generating device and an aerosol generating substrate and to a method of using the aerosol generating system to generate an aerosol to be inhaled. The present disclosure is particularly applicable to a portable (hand-held) aerosol generating device. Such devices heat, rather than burn, an aerosol generating substrate, e.g., tobacco or other suitable materials, by conduction, convection, and/or radiation to generate an aerosol for inhalation by a user. The present disclosure is particularly concerned with an inductively heated aerosol generating device and/or system.

### TECHNICAL BACKGROUND

The popularity and use of reduced-risk or modified-risk devices (also known as aerosol generating devices or vapour generating devices or personal vaporizers) has grown rapidly in recent years as an alternative to the use of traditional tobacco products. Various devices and systems are available that heat or warm aerosol generating substances to generate an aerosol for inhalation by a user.

A commonly available reduced-risk or modified-risk device is the heated substrate aerosol generating device, or so-called heat-not-burn device. Devices of this type generate an aerosol or vapour by heating an aerosol generating substrate to a temperature typically in the range 150° C. to 300° C. Heating the aerosol generating substrate to a temperature within this range, without burning or combusting the aerosol generating substrate, generates a vapour which typically cools and condenses to form an aerosol for inhalation by a user of the device.

Currently available aerosol generating devices can use one of a number of different approaches to heat to the aerosol generating substrate. One such approach is to provide an aerosol generating device which employs an induction heating system. In such a device, an induction coil is provided in the device and an inductively heatable susceptor is provided to heat the aerosol generating substrate. Electrical energy is supplied to the induction coil when a user activates the device which in turn generates an alternating electromagnetic field. The susceptor couples with the electromagnetic field and generates heat which is transferred, for example by one or more of conduction, radiation and convection to the aerosol generating substrate and an aerosol is generated as the aerosol generating substrate is heated.

It is generally desirable to control the heat distribution within the aerosol generating substrate to ensure that an aerosol with acceptable characteristics is generated for inhalation by a user throughout a period of use (also known as a smoking session). Embodiments of the present disclosure seek to provide an improved user experience in which the characteristics of the generated aerosol are optimised through more accurate control of the heat distribution within the aerosol generating substrate.

### SUMMARY OF THE DISCLOSURE

According to a first aspect of the present disclosure, there is provided an aerosol generating device comprising:
a heating chamber for receiving at least part of an aerosol generating substrate;
an induction heating arrangement configured to heat the aerosol generating substrate to generate an aerosol to be inhaled, the induction heating arrangement comprising a single induction coil disposed around or adjacent to the heating chamber;
a controller configured to control the induction heating arrangement to supply an alternating electric current to the single induction coil;
wherein the induction heating arrangement includes a plurality of connectors associated with the single induction coil, the plurality of connectors being arranged and configured to permit the supply of the alternating electric current to one or more coil sections of the single induction coil to selectively energise the one or more coil sections;
wherein the aerosol generating device comprises a plurality of inductively heatable susceptors positioned in the heating chamber adjacent to each coil section to define corresponding heating areas within the heating chamber; and
wherein the aerosol generating device comprises at least two heating modes, each heating mode comprising an associated section activation pattern, and the controller is configured to control the induction heating arrangement to supply the alternating electric current to the one or more coil sections of the single induction coil in accordance with a first section activation pattern if a first heating mode is selected, and to supply the alternating electric current to the one or more coil sections of the single induction coil in accordance with a second section activation pattern, different to the first, if a second heating mode is selected.

The aerosol generating device is configured to heat an aerosol generating substrate, without burning the aerosol generating substrate, to volatise at least one component of the aerosol generating substrate and thereby generate a heated vapour which cools and condenses to form an aerosol for inhalation by a user of the aerosol generating device. The aerosol generating device is typically a hand-held, portable, device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

By selectively energising one or more of the coil sections, the present disclosure enables the heat distribution within an aerosol generating substrate to be carefully controlled, for example because each coil section (when energised) may cause preferential heating of the inductively heatable susceptor that is located adjacent to that particular coil section. Thus, selective (or “zonal”) heating of the aerosol generating substrate can be achieved. The use of a single induction coil having coil sections which can be selectively energised (either sequentially or simultaneously) via the connectors provides an effective solution for selectively heating the inductively heatable susceptors and ensures that the aerosol generating device has a compact design. By providing the inductively heatable susceptors as part of the aerosol generating device rather than with the aerosol generating substrate as part of an aerosol generating article, the structure and manufacture of the aerosol generating article can also be simplified. By providing two or more heating modes each having an associated section activation pattern (i.e. a pre-defined order in which the coil sections are to be activated), the aerosol generating device is switchable between a plurality of heating modes tailoring the operation of the device, and so may provide a user with more flexibility as to the operation of the device. Further, the plurality of heating modes may provide for more consistent heating during a usage session.

Optional features will now be set out. These are applicable singly or in any combination with any aspect of the present disclosure.

The connectors may be arranged in pairs to permit the supply of the alternating electric current to each coil section via a corresponding pair of the connectors. The controller may be configured to supply the alternating electric current to each coil section via a corresponding pair of the connectors. Thus, each coil section is defined by, and can be conveniently energised via, a selected pair of the connectors.

The plurality of connectors may be arranged and configured so that, in use, each coil section generates an electromagnetic field concentrated in a different region of the heating chamber, for example corresponding to the location of an adjacently positioned inductively heatable susceptor. This ensures that an inductively heatable susceptor positioned adjacent to a coil section is preferentially heated by the electromagnetic field generated by that coil section.

The single induction coil may be a helical coil which may extend around the heating chamber about a longitudinal axis. By providing an induction coil which extends helically around the heating chamber, reliable heating of the inductively heatable susceptors can be assured. The plurality of connectors may be spaced along the longitudinal axis to define longitudinally arranged coil sections and, thus, each coil section may comprise a subset of turns of the total number of turns of the helical coil. The inductively heatable susceptors may be correspondingly spaced along the longitudinal axis, thus providing for selective (or “zonal”) heating of longitudinally arranged portions of the aerosol generating substrate.

In a first section activation pattern, the controller may be configured to supply the alternating electric current sequentially to each coil section individually. In a second section activation pattern, the controller may be configured to supply the alternating electric current sequentially to a plurality of subsets of coil sections. Thus, each coil section, or subset of coil sections, may generate an electromagnetic field at different times (i.e., not all of the coil sections simultaneously generate an electromagnetic field). This conveniently allows different regions or portions of an aerosol generating substrate to be sequentially heated, thus providing for controlled heat distribution within the aerosol generating substrate and, in particular, selective (or “zonal”) heating. In a third section activation pattern, the controller may be configured to supply the alternating electric current simultaneously to all of the coil sections. Thus, rapid heating of the aerosol generating substrate may be achieved.

The controller may be configured to control the induction heating arrangement to supply an alternating electric current to a first coil section to generate a first electromagnetic field. The controller may be configured to control the induction heating arrangement to supply an alternating electric current to a second coil section to generate a second electromagnetic field.

The first and second electromagnetic fields may not be generated simultaneously. but instead at different times. This conveniently allows different regions or portions of an aerosol generating substrate to be sequentially heated. thus providing for controlled heat distribution within the aerosol generating substrate and, in particular, selective (or “zonal”) heating.

The first electromagnetic field may have a first frequency and the second electromagnetic field may have a second frequency that is different from the first frequency. By generating first and second electromagnetic fields with first and second frequencies that differ from each other, the heat distribution within an aerosol generating substrate can be carefully controlled, for example because the first electromagnetic field may cause preferential heating of a first inductively heatable susceptor and the second electromagnetic field may cause preferential heating of a second inductively heatable susceptor. Thus, selective (or “zonal”) heating of the aerosol generating substrate can be achieved. The use of a single induction coil for generating the first electromagnetic field (e.g., via a first coil section) and the second electromagnetic field (e.g., via a second coil section) provides an effective solution for generating the first and second electromagnetic fields and ensures that the aerosol generating device has a compact design.

Each of the plurality of inductively heatable susceptors may have a resonant frequency that is different to the resonant frequency of the other inductively heatable susceptors. For example, the aerosol generating device may comprise a first inductively heatable susceptor having a first resonant frequency and may comprise a second inductively heatable susceptor having a second resonant frequency that is different from the first resonant frequency.

Using inductively heatable susceptors with different resonant frequencies permits selective (or “zonal”) heating of the aerosol generating substrate to be carried out by controlling the induction heating arrangement so that the first coil section generates a first electromagnetic field with a first frequency that is substantially equal to the first resonant frequency of the first inductively heatable susceptor and so that the second coil section generates a second electromagnetic field with a second frequency that is substantially equal to the second resonant frequency of the second inductively heatable susceptor. Generating an electromagnetic field (e.g., first or second electromagnetic field) with a frequency (e.g., first or second frequency) that is substantially equal to the resonant frequency (e.g., first or second resonant frequency) of a particular susceptor (e.g., first or second susceptor) will cause that susceptor to generate a heat amount. It may also cause one or more of the other susceptors (i.e., any susceptor that has a resonant frequency that is not substantially equal to the frequency of the generated electromagnetic field) to generate a heat amount that is typically less than the heat amount generated by the particular susceptor, and which may be zero or substantially zero. Any selective heating of a particular susceptor should not, therefore, be construed as meaning that the other susceptors are not heated at all, but only that the selective heating of the particular susceptor will typically be primarily responsible for the release of aerosol from aerosol generating substrate adjacent to the particular susceptor. The term “preferential heating” is used throughout the specification to define this type of heating. This preferential heating may advantageously allow one or more portions of the aerosol generating substrate to be heated to a higher temperature than one or more other portions of the aerosol generating substrate. The one or more portions heated to the higher temperature may provide for rapid aerosol generation when the aerosol generating device is first activated whilst the one or more portions heated to the lower temperature may provide for sustained aerosol generation throughout a period of use (e.g., a smoking session).

The controller may be configured to control the induction heating arrangement to supply an alternating electric current to a third coil section to generate a third electromagnetic field. The controller may be configured to control the induction heating arrangement to supply an alternating electric current to a fourth coil section to generate a fourth electromagnetic field. The third electromagnetic field may have a third frequency. The fourth electromagnetic field may have a fourth frequency. The third frequency may be different from the first and second frequencies and may be different from the fourth frequency. The fourth frequency may be different from the first and second frequencies and may be different from the third frequency. The third electromagnetic field, with its third frequency, may be adapted to heat a third inductively heatable susceptor that may have a third resonant frequency that may be different from the first and second resonant frequencies and that may be different from the fourth resonant frequency. The fourth electromagnetic field, with its fourth frequency, may be adapted to heat a fourth inductively heatable susceptor that may have a fourth resonant frequency that may be different from the first and second resonant frequencies and that may be different from the third resonant frequency.

The use of additional coil sections, such as a third coil section and optionally a fourth coil section, along with inductively heatable susceptors having corresponding third and fourth resonant frequencies, allows greater control over the heating of the aerosol generating substrate, and thus may enhance the selective (or “zonal”) heating of the aerosol generating substrate.

In the first heating mode, the controller may be configured to control the induction heating arrangement to sequentially supply an alternating electric current to each of the first, second, third and fourth coil sections in the first section activation pattern. In an example first section activation pattern, each of the first, second, third and fourth inductively heatable susceptors is sequentially heated so that first, second, third and fourth portions of the aerosol generating substrate are sequentially heated. Heating may start with any one of the first, second, third and fourth sections. If required, the sequence may be reversed. The coil may comprise more than four sections, or fewer than four sections.

In the second heating mode, the controller may be configured to control the induction heating arrangement to simultaneously supply an alternating electric current to a first subset of the coil sections and thereafter to simultaneously supply an alternating electric current to a second subset of the coil sections in the second section activation pattern. In an example second section activation pattern, the controller may be configured to simultaneously supply an alternating electric current to the first and second coil sections and thereafter to simultaneously supply an alternating electric current to the third and fourth coil sections. In this example, the first and second inductively heatable susceptors are simultaneously heated so that first and second portions of the aerosol generating substrate are also simultaneously heated. Thereafter, the third and fourth inductively heatable susceptors are simultaneously heated so that third and fourth portions of the aerosol generating substrate are also simultaneously heated. In another example, the first and third inductively heatable susceptors are simultaneously heated so that first and third portions of the aerosol generating substrate are also simultaneously heated. Thereafter, the second and fourth inductively heatable susceptors are simultaneously heated so that second and fourth portions of the aerosol generating substrate are also simultaneously heated. In a further example the first and fourth inductively heatable susceptors are simultaneously heated so that first and fourth portions of the aerosol generating substrate are also simultaneously heated. Thereafter, the second and third inductively heatable susceptors are simultaneously heated so that second and third portions of the aerosol generating substrate are also simultaneously heated. It will be appreciated that the subsets may be activate in a different order, and that other subsets may be selected if required.

In a third heating mode, the controller may be configured to control the induction heating arrangement to simultaneously supply an alternating electric current to the first, second, third and fourth coil sections in a third section activation pattern. In this example, the first, second, third and fourth inductively heatable susceptors are simultaneously heated so that first, second, third and fourth portions of the aerosol generating substrate are simultaneously heated.

It will be appreciated that other combinations of coil sections and subsets of coil sections may be selected in order to define further example section activation patterns. For example, in a further sequential section activation pattern, a first coil section is activated, followed by a first subset of coil sections including a second coil section and a third coil section, followed by a fourth coil section.

The controller may be configured to control the induction heating arrangement to heat a first coil section within a subset of coil sections (for example, the first subset) to a first temperature and to simultaneously heat a second coil section within the same subset to the second temperature.

The controller may be user adjustable or user configurable to enable the user to control, via the induction heating arrangement, the supply of alternating electric current to the coil sections. In other words, a user may choose how the plurality of coil sections are energised, for example according to the first, second or third non-limiting examples described above. These non-limiting first, second and third examples may represent “heating modes” of the aerosol generating device which a user may select.

The induction coil may comprise a Litz wire or a Litz cable. It will, however, be understood that other materials could be used.

The induction coil may be arranged to operate in use with a fluctuating electromagnetic field having a magnetic flux density of between approximately 20 mT and approximately 2.0 T at the point of highest concentration.

The heating chamber may have a longitudinal axis defining a longitudinal direction. The heating chamber may be substantially tubular. The inductively heatable susceptors may extend circumferentially around the periphery of the substantially tubular heating chamber and may, for example, comprise susceptor rings. As noted above, the inductively heatable susceptors may be spaced along the heating chamber in the longitudinal direction, i.e., along the longitudinal axis. The heating chamber may be substantially cylindrical. Thus, the heating chamber may be configured to receive a substantially cylindrical aerosol generating substrate which may be advantageous as, often, aerosol generating substrates in the form of aerosol generating articles are packaged and sold in a cylindrical form. The inductively heatable susceptors are heated efficiently in the presence of an electromagnetic field generated by an adjacent coil section, thereby ensuring that the aerosol generating substrate is heated rapidly and uniformly. The energy efficiency of the aerosol generating device is thereby maximised.

The heating chamber may comprise a substantially non-electrically conductive and non-magnetically permeable material. For example, the heating chamber may comprise a heat-resistant plastics material, such as polyether ether ketone (PEEK). The heating chamber itself is not heated by the induction heating arrangement during operation of the aerosol generating device, ensuring that energy input into the inductively heatable susceptors is maximised. This in turn helps to ensure that the energy efficiency of the device is maximised. The device also remains cool to the touch, ensuring that user comfort is maximised.

The inductively heatable susceptors may comprise a metal. The metal is typically selected from the group consisting of stainless steel and carbon steel. The inductively heatable susceptors could, however, comprise any suitable material including one or more, but not limited, of aluminium, iron, nickel, stainless steel, carbon steel, and alloys thereof, e.g. Nickel Chromium or Nickel Copper. With the application of an electromagnetic field in its vicinity, each inductively heatable susceptor generates heat due to eddy currents and magnetic hysteresis losses resulting in a conversion of energy from electromagnetic to heat.

The aerosol generating device may include a power source and the controller may include control circuitry. The power source and control circuitry may be configured to operate at a high frequency. The power source and control circuitry may be configured to operate at a frequency of between approximately 80 kHz and 1 MHz, possibly between approximately 150 kHz and 250 kHz, and possibly at approximately 200 kHz. The power source and control circuitry could be configured to operate at a higher frequency, for example in the MHz range, depending on the type of inductively heatable susceptors that are used.

According to a second aspect of the present disclosure, there is provided an aerosol generating system comprising:
an aerosol generating substrate; and
an aerosol generating device as defined above for heating the aerosol generating substrate to generate an aerosol to be inhaled.

The aerosol generating substrate may comprise any type of solid or semi-solid material. Example types of aerosol generating solids include powder, granules, pellets, shreds, strands, particles, gel, strips, loose leaves, cut filler, porous material, foam material or sheets. The aerosol generating substrate may comprise plant derived material and in particular, may comprise tobacco. It may advantageously comprise reconstituted tobacco, for example including tobacco and any one or more of cellulose fibres, tobacco stalk fibres and inorganic fillers such as CaCO3.

Consequently, the aerosol generating device may be referred to as a “heated tobacco device”, a “heat-not-burn tobacco device”, a “device for vaporising tobacco products”, and the like, with this being interpreted as a device suitable for achieving these effects. The features disclosed herein are equally applicable to devices which are designed to vaporise any aerosol generating substrate.

The aerosol generating substrate may form part of an aerosol generating article and may be circumscribed by a paper wrapper.

The aerosol generating article may be formed substantially in the shape of a stick, and may broadly resemble a cigarette, having a tubular region with an aerosol generating substrate arranged in a suitable manner. The aerosol generating article may include a filter segment, for example comprising cellulose acetate fibres, at a proximal end of the aerosol generating article. The filter segment may constitute a mouthpiece filter and may be in coaxial alignment with the aerosol generating substrate. One or more vapour collection regions, cooling regions, and other structures may also be included in some designs. For example, the aerosol generating article may include at least one tubular segment upstream of the filter segment. The tubular segment may act as a vapour cooling region. The vapour cooling region may advantageously allow the heated vapour generated by heating the aerosol generating substrate to cool and condense to form an aerosol with suitable characteristics for inhalation by a user, for example through the filter segment.

The aerosol generating substrate may comprise an aerosol-former. Examples of aerosol-formers include polyhydric alcohols and mixtures thereof such as glycerine or propylene glycol. Typically, the aerosol generating substrate may comprise an aerosol-former content of between approximately 5% and approximately 50% on a dry weight basis. In some embodiments, the aerosol generating substrate may comprise an aerosol-former content of between approximately 10% and approximately 20% on a dry weight basis, and possibly approximately 15% on a dry weight basis.

Upon being heated by one or more of the plurality of inductively heatable susceptors, the aerosol generating substrate may release volatile compounds. The volatile compounds may include nicotine or flavour compounds such as tobacco flavouring.

According to a third aspect of the present disclosure, there is provided a method of using an aerosol generating system as defined above, the method comprising:
positioning at least part of the aerosol generating substrate in the heating chamber;
controlling, by the controller, the induction heating arrangement to supply an alternating electric current to the one or more coil sections of the single induction coil in accordance with a first section activation pattern if a first heating mode is selected; and
controlling, by the controller, the induction heating arrangement to supply the alternating electric current to the one or more coil sections of the single induction coil in accordance with a second section activation pattern, different to the first, if a second heating mode is selected.

Supplying the alternating electric current in accordance with the first section activation pattern may comprise actuating, by the controller, the induction heating arrangement to supply an alternating electric current to a first coil section for a first period of time to generate a first electromagnetic field for the first period of time to heat a first portion of the aerosol generating substrate and subsequently actuating, by the controller, the induction heating arrangement to supply an alternating electric current to a second coil section for a second period of time which follows the first period of time to generate the second electromagnetic field for the second period of time to heat a second portion of the aerosol generating substrate.

Supplying the alternating electric current in accordance with the second section activation pattern may comprise actuating, by the controller, the induction heating arrangement to supply an alternating electric current to a first subset of coil sections for a first period of time to generate a first group of electromagnetic fields for the first period of time to heat a first group of portions of the aerosol generating substrate and subsequently actuating, by the controller, the induction heating arrangement to supply an alternating electric current to a second subset of coil sections (different to the first suset) for a second period of time which follows the first period of time to generate the second group of electromagnetic field for the second period of time to heat a second group of portions of the aerosol generating substrate.

The first electromagnetic field may cause preferential heating of a first inductively susceptor during the first period of time and the second electromagnetic field may cause preferential heating of a second inductively heatable susceptor during the second period of time. Thus, the first inductively heatable susceptor may be heated to a higher temperature than the second inductively heatable susceptor during the first period of time whereas the second inductively heatable susceptor may be heated to a higher temperature than the first inductively heatable susceptor during the second period of time. As noted above, this provides for controlled heat distribution within the aerosol generating substrate and, in particular, provides for selective (or “zonal”) heating.

The step of actuating, by the controller, the induction heating arrangement to supply the alternating electric current to the first coil section may cause the generated first electromagnetic field to heat a first inductively heatable susceptor that may define a first heating area of the heating chamber in which the first portion of the aerosol generating substrate may be positioned. The step of actuating, by the controller, the induction heating arrangement to supply the alternating electric current to the second coil section may cause the generated second electromagnetic field to heat a second inductively heatable susceptor that may define a second heating area of the heating chamber in which the second portion of the aerosol generating substrate may be positioned.

The method thus provides for selective (or “zonal”) heating of the aerosol generating substrate in the first and second heating areas. For example, the first portion of the aerosol generating substrate positioned in the first heating area is heated by the first inductively heatable susceptor and the second portion of the aerosol generating substrate positioned in the second heating area is heated by the second inductively heatable susceptor. As noted above, the heating of the first and second portions of the aerosol generating substrate can be sequential or simultaneous, depending on user preference, and may be controlled by a user.

### BRIEF DESCRIPTION OF THE DRAWINGS

FIG. 1 is a diagrammatic cross-sectional view of an aerosol generating system comprising an aerosol generating device and an aerosol generating article ready to be positioned in a heating chamber of the aerosol generating device;

FIG. 2 is a diagrammatic cross-sectional view of the aerosol generating system of FIG. 1, showing the aerosol generating article positioned in the heating chamber of the aerosol generating device;

FIG. 3 is a detailed diagrammatic perspective view of the heating chamber of the aerosol generating device of FIGS. 1 and 2, showing first, second, third and fourth inductively heatable susceptors mounted on an inner surface of the heating chamber and a coil support structure;

FIG. 4 is a diagrammatic cross-sectional view from an end of the heating chamber shown in FIG. 3, showing a fourth inductively heatable susceptor extending around a periphery of the heating chamber; and

FIG. 5 is a diagrammatic perspective view of part of the aerosol generating device of FIGS. 1 to 4, showing the induction coil and inductively heatable susceptors of the aerosol generating device, and also showing the aerosol generating article positioned with respect to the inductively heatable susceptors.

### DETAILED DESCRIPTION OF EMBODIMENTS

Embodiments of the present disclosure will now be described by way of example only and with reference to the accompanying drawings.

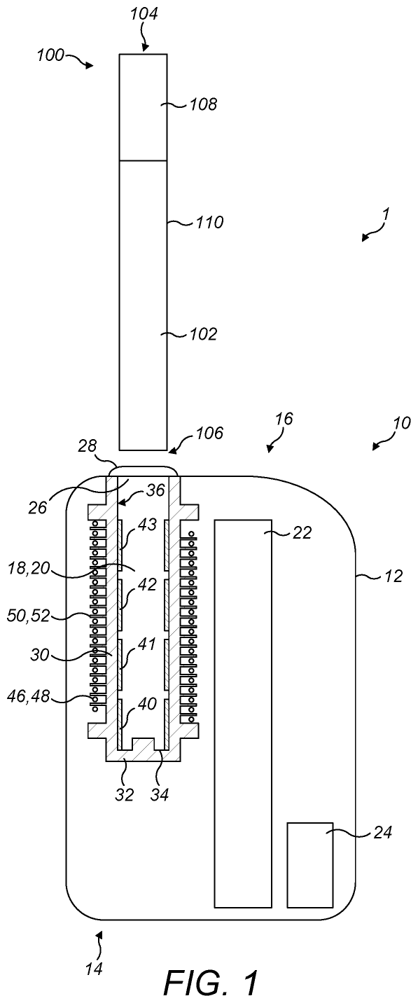

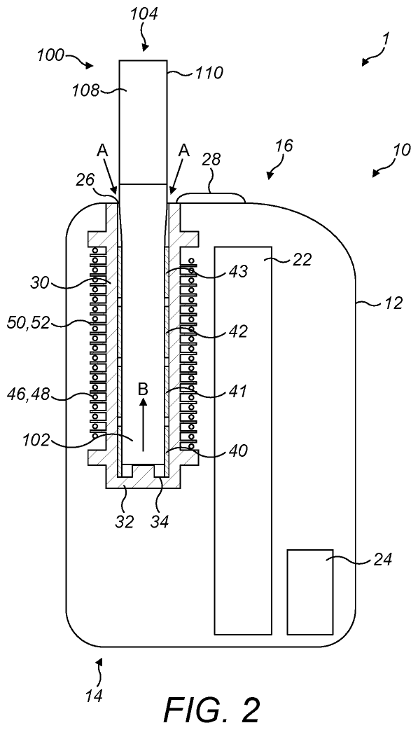

Referring initially to FIGS. 1 and 2, there is shown diagrammatically an example of an aerosol generating system 1. The aerosol generating system 1 comprises an aerosol generating device 10 and an aerosol generating article 100 for use with the device 10. The aerosol generating device 10 comprises a main body 12 housing various components of the aerosol generating device 10. The main body 12 can have any shape that is sized to fit the components described in the various embodiments set out herein and to be comfortably held by a user unaided, in a single hand.

A first end 14 of the aerosol generating device 10, shown towards the bottom of FIGS. 1 and 2, is described for convenience as a distal, bottom, base or lower end of the aerosol generating device 10. A second end 16 of the aerosol generating device 10, shown towards the top of FIGS. 1 and 2, is described as a proximal, top or upper end of the aerosol generating device 10. During use, the user typically orients the aerosol generating device 10 with the first end 14 downward and/or in a distal position with respect to the user's mouth and the second end 16 upward and/or in a proximate position with respect to the user's mouth.

The aerosol generating device 10 comprises a heating chamber 18 positioned in the main body 12. The heating chamber 18 defines an interior volume in the form of a cavity 20 having a substantially cylindrical cross-section for receiving an aerosol generating article 100. The heating chamber 18 has a longitudinal axis defining a longitudinal direction and is formed of a heat-resistant plastics material, such as polyether ether ketone (PEEK). The aerosol generating device 10 further comprises a power source 22, for example one or more batteries which may be rechargeable, and a controller 24.

The heating chamber 18 is open towards the second end 16 of the aerosol generating device 10. In other words, the heating chamber 18 has an open first end 26 towards the second end 16 of the aerosol generating device 10. The heating chamber 18 is typically held spaced apart from the inner surface of the main body 12 to minimise heat transfer to the main body 12.

The aerosol generating device 10 can optionally include a sliding cover 28 movable transversely between a closed position (see FIG. 1) in which it covers the open first end 26 of the heating chamber 18 to prevent access to the heating chamber 18 and an open position (see FIG. 2) in which it exposes the open first end 26 of the heating chamber 18 to provide access to the heating chamber 18. The sliding cover 28 can be biased to the closed position in some embodiments.

The heating chamber 18, and specifically the cavity 20, is arranged to receive a correspondingly shaped generally cylindrical or rod-shaped aerosol generating article 100. Typically, the aerosol generating article 100 comprises a pre-packaged aerosol generating substrate 102. The aerosol generating article 100 is a disposable and replaceable article (also known as a “consumable”) which may, for example, contain tobacco as the aerosol generating substrate 102. The aerosol generating article 100 has a proximal end 104 (or mouth end) and a distal end 106. The aerosol generating article 100 further comprises a mouthpiece segment 108 positioned downstream of the aerosol generating substrate 102. The aerosol generating substrate 102 and the mouthpiece segment 108 are arranged in coaxial alignment inside a wrapper 110 (e.g., a paper wrapper) to hold the components in position to form the rod-shaped aerosol generating article 100.

The mouthpiece segment 108 can comprise one or more of the following components (not shown in detail) arranged sequentially and in co-axial alignment in a downstream direction, in other words from the distal end 106 towards the proximal (mouth) end 104 of the aerosol generating article 100: a cooling segment, a center hole segment and a filter segment. The cooling segment typically comprises a hollow paper tube having a thickness which is greater than the thickness of the wrapper 110. The center hole segment may comprise a cured mixture containing cellulose acetate fibres and a plasticizer, and functions to increase the strength of the mouthpiece segment 108. The filter segment typically comprises cellulose acetate fibres and acts as a mouthpiece filter. As heated vapour flows from the aerosol generating substrate 102 towards the proximal (mouth) end 104 of the aerosol generating article 100, the vapour cools and condenses as it passes through the cooling segment and the center hole segment to form an aerosol with suitable characteristics for inhalation by a user through the filter segment.

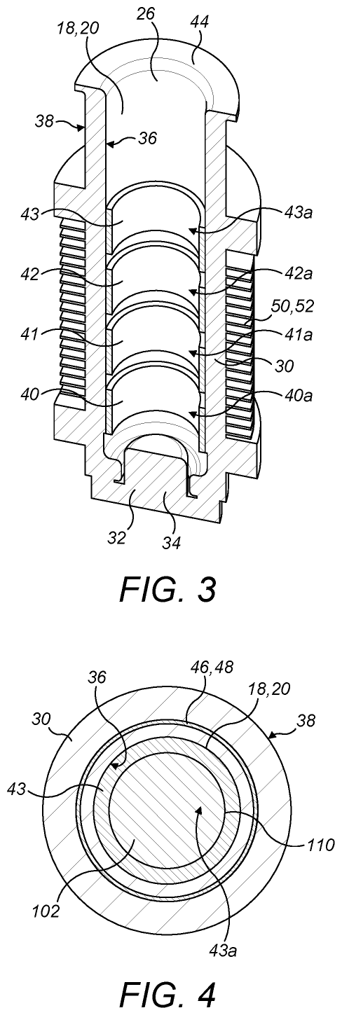

Referring also to FIGS. 3 and 4, the heating chamber 18 has a side wall (or chamber wall) 30 extending between a base 32, located at a second end 34 of the heating chamber 18, and the open first end 26. The side wall 30 and the base 32 are connected to each other and can be integrally formed as a single piece. In the illustrated embodiment, the side wall 30 is tubular and, more specifically, cylindrical. In other embodiments, the side wall 30 can have other suitable shapes, such as a tube with an elliptical or polygonal cross section. In yet further embodiments, the side wall 30 can be tapered.

In the illustrated embodiment, the base 32 of the heating chamber 18 is closed, e.g., sealed or air-tight. That is, the heating chamber 18 is cup-shaped. This can ensure that air drawn from the open first end 26 is prevented by the base 32 from flowing out of the second end 34 and is instead guided through the aerosol generating substrate 102. It can also ensure that a user inserts the aerosol generating article 100 into the heating chamber 18 an intended distance and no further.

The side wall 30 of the heating chamber 18 has an inner surface 36 and an outer surface 38. The aerosol generating device 10 comprises first, second, third and fourth inductively heatable susceptors 40, 41, 42, 43 mounted on the inner surface 36 of the side wall 30 within the cavity 20. In the illustrated example, each of the inductively heatable susceptors 40, 41, 42, 43 is ring-shaped and circumscribes an angle of 360°. That is, the inductively heatable susceptors 40, 41. 42, 43 comprise susceptor rings which extend around the entire inner surface 36 of the side wall 30 in the circumferential direction. The inductively heatable susceptors 40, 41, 42, 43 are spaced in the longitudinal direction within the heating chamber 18 (i.e., they are spaced along the longitudinal axis of the heating chamber 18) between the open first end 26 and the closed second end 34. Each of the first, second, third and fourth inductively heatable susceptors 40, 41, 42, 43 defines a corresponding first, second, third and fourth heating area 40a, 41a, 42a, 43a within the heating chamber 18.

The inductively heatable susceptors 40, 41, 42, 43 each have an inner surface at least part of which may contact the aerosol generating substrate 102. The inductively heatable susceptors 40, 41, 42, 43 may form a friction fit with the aerosol generating substrate 102, and more particularly with the wrapper 110 of the aerosol generating article 100, and may cause compression of the aerosol generating substrate 102 as best seen in FIG. 2. The compression of the aerosol generating substrate 102 improves thermal conduction through the aerosol generating substrate 102, for example by eliminating air gaps within the aerosol generating substrate 102.

The aerosol generating device 10 comprises an induction heating arrangement 46 for heating the aerosol generating substrate 102. The induction heating arrangement 46 comprises a single, substantially helical, induction coil 48. The induction coil 48 extends helically around the substantially cylindrical heating chamber 18. The induction coil 48 can be energised by the power source 22 and controller 24 as will be discussed in further detail below. The controller 24 includes, amongst other electronic components, an inverter which is arranged to convert a direct current from the power source 22 into an alternating high-frequency current for the induction coil 48.

The side wall 30 of the heating chamber 18 includes a coil support structure 50 formed in the outer surface 38. In the illustrated example, the coil support structure 50 comprises a coil support groove 52 which extends helically around the outer surface 38. The induction coil 48 is positioned in the coil support groove 52 and is, thus, securely and optimally positioned with respect to the inductively heatable susceptors 40, 41, 42, 43.

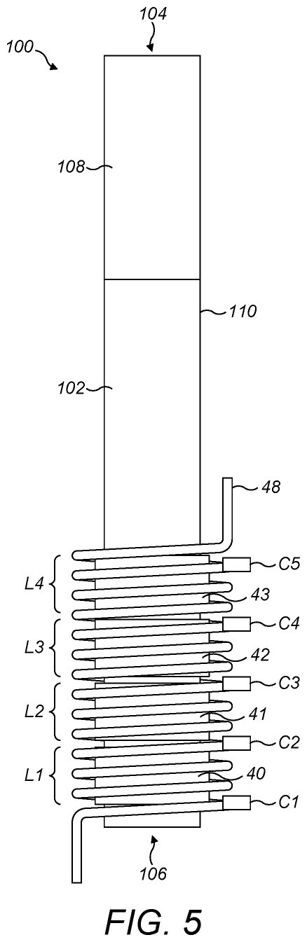

Referring now to FIG. 5, the induction heating arrangement 46 further comprises a plurality of connectors C1, C2, C3, C4, C5 spaced along the longitudinal axis of the heating chamber 18 to define a plurality of longitudinally arranged coil sections L1, L2, L3, L4 of the induction coil 48. Each coil section L1-L4 comprises a subset of turns of the total number of turns of the induction coil 48. Purely by way of example, in illustrated embodiment each coil section L1-L4 comprises approximately three turns of the induction coil 48. Each coil section L1-L4 is defined by a pair of the connectors C1-C5. More specifically, the first coil section L1 is defined by connector pair C1 and C2, the second coil section L2 is defined by connector pair C2 and C3, the third coil section L3 is defined by connector pair C3 and C4, and the fourth coil section L4 is defined by connector pair C4 and C5. It should be noted that the provision of four coil sections L1-L4 is not compulsory, and that more or less than four coil sections L1-L4 can be provided by using an appropriate number of connectors.

As will be apparent from FIG. 5, the first inductively heatable susceptor 40 is positioned adjacent to the first coil section L1, the second inductively heatable susceptor 41 is positioned adjacent to the second coil section L2, the third inductively heatable susceptor 42 is positioned adjacent to the third coil section L3, and the fourth inductively heatable susceptor 43 is positioned adjacent to the fourth coil section L4. The controller 24 is configured to supply an alternating electric current to one or more of the coil sections L1-L4 via one or more of the corresponding pairs of electrical connectors C1-C5 to selectively energise one or more of the coil sections L1-L4. This causes preferential heating of the inductively heatable susceptor 40, 41, 42, 43 that is positioned adjacent to each coil section L1-L4, as will be described in further detail below. The controller has a plurality of heating modes, each having an associated section activation pattern (i.e. a sequence or order in which each segment or group of segments is to be activated). Thus the aerosol generating device may selectively activate a selected one of the heating modes (which may be pre-programmed or otherwise stored in a memory of the aerosol generating device) for operation, and may switch between two or more of the heating modes (e.g. in accordance with a user input or in dependence on a type of aerosol generating substrate to be heated).

In order to use the aerosol generating device 10, a user displaces the sliding cover 28 (if present) from the closed position shown in FIG. 1 to the open position shown in FIG. 2. The user then inserts an aerosol generating article 100 through the open first end 26 into the heating chamber 18, so that the aerosol generating substrate 102 is received in the cavity 20 and so that the proximal end 104 of the aerosol generating article 100 is positioned at the open first end 26 of the heating chamber 18, with at least part of the mouthpiece segment 108 projecting from the open first end 26 to permit engagement by a user's lips.

Upon activation of the aerosol generating device 10 by a user, the induction heating arrangement 46 is energised by the power source 22 and controller 24. More specifically, and in accordance with the present disclosure, the controller 24 is configured to control the induction heating arrangement 46, and more particularly the power source 22 and control circuitry, to supply an alternating electric current to one or more of the coil sections L1-L4 to selectively energise one or more of the coil sections L1-L4. In some examples, when one of the first, second, third and fourth coil sections L1-L4 is energised, it may generate a corresponding first electromagnetic field, second electromagnetic field. third electromagnetic field and fourth electromagnetic field. These first, second, third and fourth electromagnetic fields generated by the corresponding first, second, third and fourth coil sections L1, L2, L3, L4 may each have a corresponding first frequency, second frequency, third frequency and fourth frequency. These first, second, third and fourth frequencies all differ from each other.

The first, second, third and fourth inductively heatable susceptors 40, 41, 42, 43 have different resonant frequencies. The first electromagnetic field with the first frequency causes preferential heating of the first inductively heatable susceptor 40 (by virtue of eddy currents and/or magnetic hysteresis losses generated in the first inductively heatable susceptor 40), and thus preferential heating of a first portion of the aerosol generating substrate 102 that is positioned in the first heating area 40a by heat transferred from the first inductively heatable susceptor 40. The second electromagnetic field with the second frequency causes preferential heating of the second inductively heatable susceptor 41 (by virtue of eddy currents and/or magnetic hysteresis losses generated in the second inductively heatable susceptor 41), and thus preferential heating of a second portion of the aerosol generating substrate 102 that is positioned in the second heating area 41a by heat transferred from the second inductively heatable susceptor 41. The third electromagnetic field with the third frequency causes preferential heating of the third inductively heatable susceptor 42 (by virtue of eddy currents and/or magnetic hysteresis losses generated in the third inductively heatable susceptor 42), and thus preferential heating of a third portion of the aerosol generating substrate 102 that is positioned in the third heating area 42a by heat transferred from the third inductively heatable susceptor 42. The fourth electromagnetic field with the fourth frequency causes preferential heating of the fourth inductively heatable susceptor 43 (by virtue of eddy currents and/or magnetic hysteresis losses generated in the fourth inductively heatable susceptor 43), and thus preferential heating of a fourth portion of the aerosol generating substrate 102 that is positioned in the fourth heating area 43a by heat transferred from the fourth inductively heatable susceptor 43. Thus, selective (or “zonal”) heating of first, second, third and fourth portions of the aerosol generating substrate 102 is achieved in the first, second, third and fourth heating areas 40a, 41a, 42a, 43a within the heating chamber 18. When the aerosol generating substrate 102 is heated by one or more of the first, second, third and fourth inductively heatable susceptor 40, 41, 42, 43, it results in heating of the aerosol generating substrate 102 (or at least a portion thereof) without combustion or burning, and a vapour is thereby generated. The generated vapour cools and condenses to form an aerosol which can be inhaled by a user of the aerosol generating device 10 through the mouthpiece segment 108, and more particularly through the filter segment.

In a first example heating mode, the controller 24 is operable in accordance with a first section activation pattern, in which the controller can be configured to supply an alternating electric current to the first coil section L1 (via connector pair C1 and C2) for a first period of time to energise the first coil section L1 and generate the first electromagnetic field (with its first frequency) for the first period of time, thereafter to supply an alternating electric current to the second coil section L2 (via connector pair C2 and C3) for a second period of time to energise the second coil section L2 and to generate the second electromagnetic field (with its second frequency) for the second period of time, thereafter to supply an alternating electric current to the third coil section L3 (via connector pair C3 and C4) for a third period of time to energise the third coil section L3 and to generate the third electromagnetic field (with its third frequency) for the third period of time, and thereafter to supply an alternating electric current to the fourth coil section L4 (via connector pair C4 and C5) for a fourth period of time to energise the fourth coil section L4 and to generate the fourth electromagnetic field (with its fourth frequency) for the fourth period of time. This causes sequential preferential heating of the first, second, third and fourth inductively heatable susceptors 40, 41, 42, 43 and, thus, sequential (or “zonal” or “segmental”) heating of first, second, third and fourth portions of the aerosol generating substrate 102 that are positioned respectively in the first, second, third and fourth heating areas 40a, 41a, 42a, 43a. This heating mode provides progressive heating of the aerosol generating substrate 102, in a direction from the distal end 106 towards the proximal end 104 of the aerosol generating article 100 and may provide for the generation of a uniform amount of aerosol throughout a period of use (e.g., a smoking session).

In a second example heating mode, the controller 24 is operable in accordance with a second section activation pattern, in which the controller can be configured to simultaneously supply an alternating electric current to the first and second coil sections L1, L2 (via connector pair C1 and C2 and via connector pair C2 and C3) for a first period of time to energise the first and second coil sections L1, L2 and generate first and second electromagnetic fields (with their first and second frequencies) for the first period of time. The controller 24 can be configured to then simultaneously supply an alternating electric current to the third and fourth coil sections L3, L4 (via connector pair C3 and C4 and via connector pair C4 and C5) for a second period of time to energise the third and fourth coil sections L3, L4 and generate third and fourth electromagnetic fields (with their third and fourth frequencies) for the second period of time. This initially causes simultaneous preferential heating of the first and second inductively heatable susceptors 40, 41 for the first period of time and, thereafter, causes simultaneous preferential heating of the third and fourth inductively heatable susceptors 42, 43 for the second period of time and, thus, sequential (or “zonal” or “segmental”) heating initially of first and second portions of the aerosol generating substrate 102 that are positioned respectively in the first and second heating areas 40a, 41a of the heating chamber 18 and thereafter of third and fourth portions of the aerosol generating substrate 102 that are positioned respectively in the third and fourth heating areas 42a, 43a of the heating chamber 18. This heating mode may provide for a greater amount of aerosol generation during the first and second periods of time because two portions of the aerosol generating substrate 102 are preferentially heated during each of these periods of time.

The vaporisation of the aerosol generating substrate 102 is facilitated by the addition of air from the surrounding environment, for example through the open first end 26 of the heating chamber 18, the air being heated as it flows between the wrapper 110 of the aerosol generating article 100 and the inner surface 36 of the side wall 30, where there may be a spacing or gap (not shown) between at least part of an inner surface of each of the inductively heatable susceptors 40, 41, 42, 43 and an outer surface of the wrapper 110 forming one or more air flow paths from the open first end 26 towards the closed second end 34 of the heating chamber 18. More particularly, when a user sucks on the filter segment, air is drawn into the heating chamber 18 through the open first end 26 as illustrated by the arrows A in FIG. 2. The air entering the heating chamber 18 flows from the open first end 26 towards the closed second end 34, between the wrapper 110 and the inner surfaces of the inductively heatable susceptors 40, 41, 42, 43. When the air reaches the closed second end 34 of the heating chamber 18, it turns through approximately 180° and enters the distal end 106 of the aerosol generating article 100. The air is then drawn through the aerosol generating article 100 as illustrated by the arrow B in FIG. 2, from the distal end 106 towards the proximal (mouth) end 104 along with the generated vapour.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense: that is to say, in the sense of “including, but not limited to”.

1. An aerosol generating device, comprising:
a heating chamber for receiving at least part of an aerosol generating substrate;
an induction heating arrangement configured to heat the aerosol generating substrate to generate an aerosol to be inhaled, the induction heating arrangement comprising a single induction coil disposed around or adjacent to the heating chamber;
a controller configured to control the induction heating arrangement to supply an alternating electric current to the single induction coil;
wherein the induction heating arrangement includes a plurality of connectors associated with the single induction coil, the plurality of connectors being arranged and configured to permit the supply of the alternating electric current to one or more coil sections of the single induction coil to selectively energise the one or more coil sections;
wherein the aerosol generating device comprises a plurality of inductively heatable susceptors positioned in the heating chamber adjacent to each coil section to define corresponding heating areas within the heating chamber; and
wherein the aerosol generating device comprises at least two heating modes, each heating mode comprising an associated section activation pattern, and the controller is configured to control the induction heating arrangement to supply the alternating electric current to the one or more coil sections of the single induction coil in accordance with a first section activation pattern if a first heating mode is selected, and to supply the alternating electric current to the one or more coil sections of the single induction coil in accordance with a second section activation pattern, different than the first section activation pattern, if a second heating mode is selected.

2. An aerosol generating device according to claim 1, wherein the connectors are arranged in pairs to permit the supply of the alternating electric current to each coil section via a corresponding pair of the connectors.

3. An aerosol generating device according to claim 1, wherein the controller is configured to supply the alternating electric current to each coil section via a corresponding pair of the connectors.

4. An aerosol generating device according to claim 1, wherein the plurality of connectors are arranged and configured so that, in use, each coil section generates an electromagnetic field concentrated in a different region of the heating chamber corresponding to a location of an adjacently positioned inductively heatable susceptor.

5. An aerosol generating device according to claim 1, wherein the single induction coil is a helical coil which extends around the heating chamber about a longitudinal axis, and the plurality of connectors are spaced along the longitudinal axis to define longitudinally arranged coil sections.

6. An aerosol generating device according to claim 1, wherein in the first section activation pattern the controller is configured to supply the alternating electric current sequentially to each coil section.

7. An aerosol generating device according to claim 1, wherein in the second section activation pattern the controller is configured to supply the alternating electric current sequentially to a first subset of coil sections and thereafter to a second subset of coil sections.

8. An aerosol generating device according to claim 1, wherein the controller is configured to control the induction heating arrangement to supply an alternating electric current to a first coil section to generate a first electromagnetic field and to supply an alternating electric current to a second coil section to generate a second electromagnetic field, wherein the first electromagnetic field has a first frequency and the second electromagnetic field has a second frequency that is different from the first frequency.

9. An aerosol generating device according to claim 8, wherein the first electromagnetic field is adapted to heat a first inductively heatable susceptor having a first resonant frequency and the second electromagnetic field is adapted to heat a second inductively heatable susceptor having a second resonant frequency that is different from the first resonant frequency.

10. An aerosol generating device according to claim 8, wherein the controller is configured to control the induction heating arrangement to supply an alternating electric current to a third coil section to generate a third electromagnetic field, wherein the third electromagnetic field has a third frequency that is different from the first and second frequencies.

11. An aerosol generating device according to claim 10, wherein the third electromagnetic field is adapted to heat a third inductively heatable susceptor having a third resonant frequency that is different from the first and second resonant frequencies.

12. An aerosol generating device according to claim 1, wherein the controller is configured to control the induction heating arrangement to heat one or more of the coil sections to a first temperature, and to heat one or more other of the coil sections to a second temperature that is different than the first temperature.

13. An aerosol generating device according to claim 12, wherein the controller is configured to control the induction heating arrangement to heat a first coil section within a first subset of coil sections to the first temperature and to simultaneously heat a second coil section within the first subset of coil sections to the second temperature.

14. An aerosol generating system, comprising:
an aerosol generating substrate; and
an aerosol generating device according to claim 1 for heating the aerosol generating substrate to generate an aerosol to be inhaled.

15. A method of using an aerosol generating system according to claim 14, the method comprising:
positioning at least part of the aerosol generating substrate in the heating chamber;
controlling, by the controller, the induction heating arrangement to supply the alternating electric current to the one or more coil sections of the single induction coil in accordance with the first section activation pattern if the first heating mode is selected; and
controlling, by the controller, the induction heating arrangement to supply the alternating electric current to the one or more coil sections of the single induction coil in accordance with the second section activation pattern, different than the first section activation pattern, if the second heating mode is selected.
